(19) United States
(12) Patent Application Publication
(10) Pub. No.: US 2002/0093249 A1
(43) Pub. Date: Jul. 18, 2002

(54) Method and system for operation verification

(76) Inventor: Mark Steven Burns, (US)

Correspondence Address: Roger T. Frost, KILPATRICK STOCKTON LLP, 2400 Monarch Tower, 3424 Peachtree Road, N.E., Atlanta, GA, 30326, US

(21) Appl. No.: 09/867,325

(22) Filed: May 29, 2001

(30) Foreign Application Priority Data
May 30, 2000 (AU) PO7840

(51) Int. Cl. H02J 1/10

(52) U.S. Cl. 307/53

(57) ABSTRACT

A method of verifying operation of a plurality of power supply modules comprises the step of commencing operation of each power supply module at a predetermined time, wherein no more than one power module commences operation at any one time. A power supply system comprises a plurality of power supply modules, each power supply module being operable to commence operation at a unique predetermined time.

### TECHNICAL FIELD

The present invention relates to power supply systems, and in particular to a method and system of verifying operation of a power supply system.

### BACKGROUND TO THE INVENTION

In power supply systems in which a number of power sources act as modules of the overall system, in can be difficult to tell from the overall power supplied whether each module is functioning correctly. Failure of a single module can be difficult to identify merely from a reduction in overall system power, particularly where other factors can have an equally significant effect on the total output power. For instance, in a photovoltaic system having 10 modules. failure of a single module would cause the total power output to drop by 10%, yet other factors such as solar radiation variations could equally be the cause of such a power drop. Further, in such systems, measuring solar radiation at the panel is difficult to do accurately, and so an ‘expected’ power output of the system can itself be incorrect, further complicating an accurate analysis of system power output and correct detection of module failure. Similar factors in other types of modular power supply systems cause similar difficulties in detecting whether a lower than expected power output indicates (a) an incorrect estimation of real power output; (b) a common factor inhibiting operation of more than one module; or (c) a module failure.

Current solutions to this problem include physical inspection of each module by a technician, which, in the case of a photovoltaic power supply system, requires access to each module which could necessitate accessing a roof of a building. Alternatively, this problem can be addressed by providing individual communications protocols at least from each module to a system monitor. However, such communications significantly increases system complexity, and requires an appropriate monitor and possibly additional communications wiring and additional hardware at each module.

Any discussion of documents, acts, materials, devices, articles or the like which has been included in the present specification is solely for the purpose of providing a context for the present invention. It is not to be taken as an admission that any or all of these matters form part of the prior art base or were common general knowledge in the field relevant to the present invention as it existed in Australia before the priority date of each claim of this application.

Throughout this specification the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

### SUMMARY OF THE INVENTION

According to a first aspect the present invention provides a method of verifying operation of a plurality of power supply modules, the method comprising the step of:

commencing operation of each power supply module at a predetermined time, wherein no more than one power module commences operation at any one time.

According to a second aspect the present invention provides a power supply system comprising a plurality of power supply modules, wherein each power supply module is operable to commence operation at a unique predetermined time.

According to a third aspect the present invention provides a power supply module for use in a power supply system, the power supply module being operable to commence operation in the power supply system at a unique predetermined time.

By ensuring that no more than one power supply module commences operation at any one time (ie by providing a staggered turn-on scheme), it is possible to monitor the power contribution of each module as that module commences operation. Therefore, should one module be producing limited or no power, an increase in total system power at the predetermined time for commencement of operation of that module will be correspondingly limited, and can therefore be both detected and associated with the particular module which is malfunctioning.

The present invention also allows relative power output of each of the power supply modules to be recorded and compared to other of the modules. For instance, in photovoltaic power systems, daily readings obtained in accordance with the present invention enable ongoing analysis of module performance.

The predetermined times for commencement of operation of each of the modules are preferably sufficiently spaced apart to allow operational parameters of each module to be determined and recorded. The predetermined times for commencement of operation of each of the modules are preferably evenly spaced throughout a power-up period.

### BRIEF DESCRIPTION OF THE DRAWINGS

Embodiments of the invention will now be described by way of example, with reference to the accompanying drawings in which,

FIG. 1 illustrates a photovoltaic power supply system in accordance with the present invention;

FIG. 2 illustrates a typical output power waveforn obtained at commencement of operation of the power system; and

FIGS. 3a and 3b illustrate output power waveforms obtained at commencement of operation of the power system when one module is malfunctioning.

### DETAILED DESCRIPTION OF EMBODIMENTS OF THE INVENTION

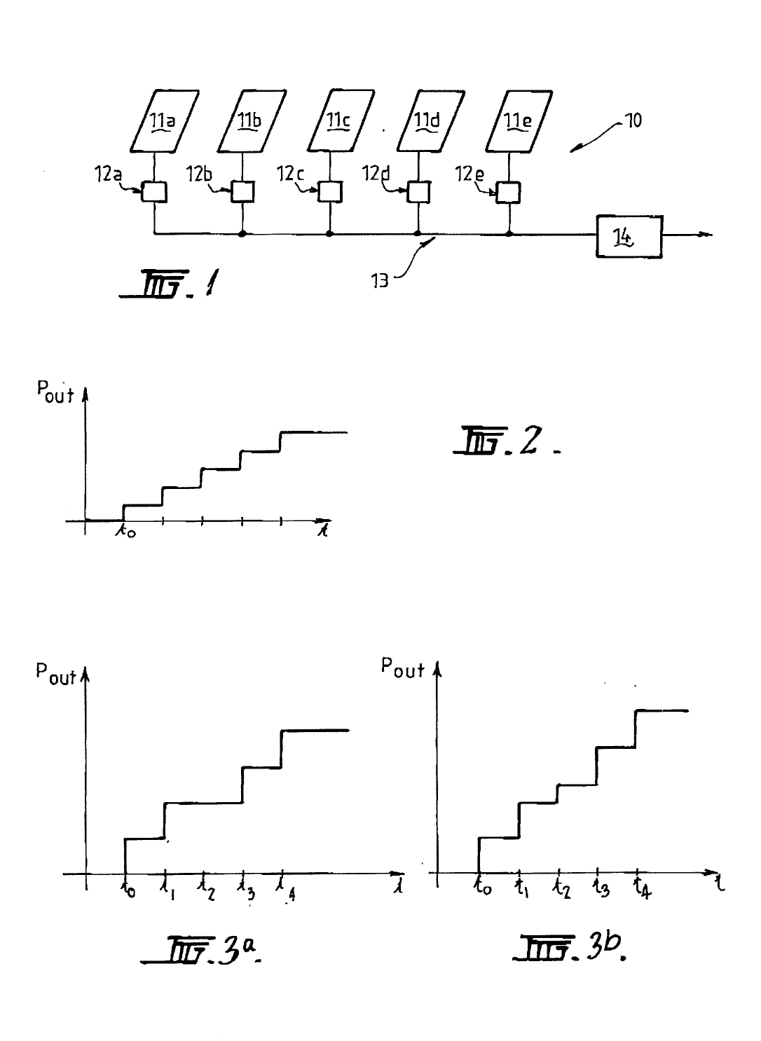

FIG. 1 illustrates a photovoltaic power supply system 10 in accordance with the present invention, including a plurality of photovoltaic power supply modules 11a-11e, connected via inverters 12a-12e over a common circuit 13 to a control unit 14. The modules 11a-11e generate DC powers which is converted to AC power by the inverters 12a-12e. Power generated by the system 10 is passed via the control unit 14 to a power sink, such as domestic appliances or a commercial distribution grid.

Prior to commencement of operation, each photovoltaic module is at an open circuit voltage. When the unit 14 energises the circuit 13, each inverter 12a-12e delays turn-on for a predetermined time. Inverter 12a commences operation immediately, inverter 12b delays for 5 seconds, inverter 12c for 10 seconds, inverter 12d for 15 seconds, and inverter 12e delays turn-on for 20 seconds. The 5 second intervals provide a period in which the power contribution of each individual module (11a-11e) can be determined by the unit 14.

When all modules 11a to 11e are operating normally, a power level supplied to unit 14 at turn-on will increase in a stepwise manner. FIG. 2 illustrates such an output power wavefprm obtained at commencement of operation of the power system 10. At time t₀, unit 14 energises the circuit 13, and inverter 12a commences operation immediately, causing a first step increase in output power Pₒᵤₜ produced by the system 10. After a delay of 5 seconds, at time t₁, inverter 12b commences operation, causing a second step increase in Pₒᵤₜ, substantially equal in size to the step increase caused at t₀. Similarly, inverters 12c, 12d and 12e commence operation at t₂, t₃ and t₄ respectively, causing further step increases, again of substantially equal size.

A turn-on waveform such as that shown in FIG. 2 indicates that all modules in a 5 module system are working normally.

FIGS. 3a and 3b illustrate output power waveforms obtained at commencement of operation of the power system 10 when one module is malfunctioning.

FIG. 3a shows that, at time t₂, no step increase in power has occurred. This enables an immediate conclusion to be reached that module 12c is not producing any output power, without the need for any further analysis or direct inspection of the modules 12a-12e. Similarly, FIG. 3b shows that, at time t₂, a significantly smaller step increase has occurred than occurred at times t₀, t₁, t₃ and t₄, indicating that module 12c is producing less power than the modules 12a, 12b, 12d and 12e, and requires attention.

It can be seen that, by ensuring that no more than one power supply module 12 commences operation at any one time (ie by providing a staggered turn-on scheme), the present invention makes it possible to monitor the power contribution of each module 12 as that module commences operation. Therefore, should one module be producing limited or no power, an increase in total system power at the predetermined time for commencement of operation of that module will be correspondingly lirnited, and can therefore be both detected and associated with the particular module which is malfunctioning.

The present invention also allows relative power output of each of the power supply modules to be recorded and compared to other of the modules as an ongoing process. For instance, in photovoltaic power systems, daily readings obtained in accordance with the present invention enable ongoing analysis of PV module performance.

It will be appreciated by persons skilled in the art that numerous variations and/or modifications may be made to the invention as shown in the specific embodiments without departing from the spirit or scope of the invention as broadly described. The present embodiments are, therefore, to be considered in all respects as illustrative and not restrictive.

1. A method of verifying operation of a plurality of power supply modules, the method comprising the step of:
commencing operation of each power supply module at a predetermined time, wherein no more than one power supply module commences operation at any one time.

2. The method of claim 1 further comprising the step of monitoring the power contribution of each power supply module as that module commences operation.

3. The method of claim 2 wherein the step of monitoring comprises measuring a total power output of the power supply system, and determining from the total power output an incremental power contribution of each of the power supply modules at the respective predetermined times.

4. The method of claim 1, wherein the respective predetermined times for commencement of operation of each of the power supply modules are sufficiently spaced apart to allow operational parameters of each module to be determined and recorded.

5. The method of claim 1, wherein the respective predetermined times for commencement of operation of each of the power supply modules are evenly spaced throughout a power-up period.

6. A power supply system comprising a plurality of power supply modules, wherein each power supply module is operable to commence operation at a unique predetermined time.

7. A power supply module for use in a power supply system, the power supply module being operable to commence operation in the power supply system at a unique predetermined time.
